(19) United States
(12) Patent Application Publication
(10) Pub. No.: US 2008/0259351 A1
(43) Pub. Date: Oct. 23, 2008

(54) Device and Method for Recognizing Particles in Milk

(76) Inventor: Magnus Wiethoff, Oelde (DE)

Correspondence Address: Jeffry W. Smith;SMITH LAW OFFICE, 440 Science Drive, Suite 302, Madison, WI, 53711, US

(21) Appl. No.: 10/592,917

(22) PCT Filed: Mar. 19, 2005
(86) PCT No.: PCT/EP2005/002943

§ 371 Date: Jun. 25, 2008

(30) Foreign Application Priority Data
Mar. 24, 2004 (DE) 102004014832.5

(51) Int. Cl. G01B 11/30; G01B 5/28

(52) U.S. Cl. 356/600; 73/105

(57) ABSTRACT

A device for recognizing particles in milk comprising a measuring surface and a housing. The measuring surface is structured so as to cause the milk to spread on the measuring surface in that the measuring surface has a specific surface roughness.

### FIELD AND BACKGROUND OF THE INVENTION

The object of the invention relates to a method and a device for recognizing particles in milk.

According to §3 of the Ordinance on Milk, the first jets of milk from each teat must be milked separately such that the milker can inspect the appearance to verify the perfect quality of the milk. A crucial criterion for a perfect quality is an absence of clots. A presence of clots in milk is an indication of udder inflammation and as such must not enter the food chain. Machine milking, in particular automatic milking (“robotic milking system”), however, cannot at present offer the capability of recognizing and separating milk containing clots.

Devices have become known by means of which milk can be examined for particles (DE 199 21 777 A1, EP 1 126 757 B1, DE 101 31 781 C1). The mere detection of particles is, however, not sufficient for determining the quality of milk since a checking for the presence of particles may degrade good quality milk as clot-containing milk if foreign matter such as straw, sand, . . . have entered it. These are not detrimental in that they are caught in the milk filter. Not even prior cleaning of the udder can entirely prevent these. Also, it is readily possible that air bubbles or foam are identified as particles. Conventional devices and methods do not allow a distinction.

A recognition requires to isolate or separate the clots or particles from the liquid. In the prior art, devices have become known which are intended to trap clots from the liquid by means of macroscopic retaining means such as a sieve or comb-like structures. A drawback of such retaining means is though that they facilitate contamination of the measuring surface.

### SUMMARY OF THE INVENTION

Therefore it is the object of the invention to provide a device and a method to allow recognition of particles in milk.

The measuring surface is structured so as to cause the milk to spread on the measuring surface in that the measuring surface has a specific surface roughness.

The invention has many advantages. One significant aspect is that milk to be examined flows across a major portion of the measuring surface and in particular across substantially the entire measuring surface. The surface roughness causes the milk sample to be examined to spread across the measuring surface. Thus the flow rate is lower and any present particles can stop on the measuring surface and the milk current will not carry them further. Carrying further will in particular occur in a milk current contracting to form one or multiple small “creeks” or “streamlets”. Adverse contracting is caused among other things by the surface tension of the sample due to which the streaming liquid assumes a small external surface.

With a measuring surface according to the invention having a certain surface roughness in the range of a few micrometers, the milk will substantially flow across the entire width of the measuring surface. This is substantially caused by the capillary action of the surface roughness which causes the milk sample to spread on the rough measuring surface.

It has been found that as the roughness increases the effect diminishes and a too high roughness can no longer guarantee an even surface spread without using other auxiliary means. This is a surprising result since higher roughness would lead to expect a better retaining effect. The reason might be that the capillary action diminishes. A roughness in the range of a few micrometers is advantageous. Therefore the range of mean roughness according to VDI (Verein Deutscher Ingenieure; German Engineer Association) Guideline 3400 edition 06/1975 is preferred.

Another drawback of higher roughness with greater roughness height is that cleaning off any present particles is more difficult. Moreover, greater roughness height or even macroscopic retaining means with retaining elements in the range of millimeters or even centimeters will increase the likelihood that the measuring surface will be contaminated or caseate. Cleaning is easily performed.

Determination of the quality of milk depends not only on the mere detection of particles but also on recognition of the particles i.e. on the type of the particles. The invention allows to separate particles from the liquid and to analyze their types.

It is possible to make a distinction not only between particle-containing milk and particle-free milk but particles are also classified. Preferably the entire sample is assigned to a specific quality grade based on the result of typing.

Detection does not take place in the volumetric milk current but the particles are separated out and identified when the milk has run off.

It is a significant advantage that the invention can be configured to be small enough to be employed in milking. Generally speaking, the size of a cigar case or a cube at an edge length in the size of a cigarette pack is sufficient. There is no need for a complicated, large construction to detect particles. The method can be applied online or quasi online so as to determine a result during the milking operation. Preferably the device according to the invention comprises the equipment required to be incorporated into a milking place or a milking stand.

A specific embodiment provides a surface roughness of the measuring surface at a typical roughness height in the range of 0.3 μm to 20 μm and preferably a roughness in the range between 0.5 μm and 5 μm and particularly preferably, a roughness height of the roughness between approx. 2 μm and 4 μm. A roughness of approx. 27 to 30 according to VDI 3400, edition 1975-06 is particularly preferred which corresponds to a roughness height of approx. 2.2 μm to 3.2 μm.

Preferably the measuring surface comprises or consists of at least one layer of a hydrophilic material so as to cause in particular the milk stream to spread on the measuring surface. The measuring surface may also be of metal such as steel and in particular high-grade steel.

According to the invention the separation of particles from the milk is improved so as to enhance the reliability and quality of the examination.

A specific embodiment of the invention provides for the measuring surface to be inclined relative to the horizontal at an angle between 0° and 10°, preferably approx. 2°. The angle is preferably such that the flow rate of the milk wave of the milk sample to be examined decelerates so that foreign particles are not flushed off but that at least part of any foreign particles remain on the measuring surface so they can be detected in particular separately.

An adjustment of parameters is possible depending on the embodiment. A conjunction is present in particular between the material of the surface of the measuring surface, its angle of inclination and the roughness such that in relation to one parameter, the others can be varied and adjusted. A suitable combination achieves the success according to the invention even with deviating parameters.

Another inventive proposal relates to an enhanced quality of illumination. The prior art uses for illumination e.g. a halogen lamp emitting light largely dependent on the spatial angle. This causes an inhomogeneous illumination of the measuring surface which is not the optimum for evaluating the particle type. The radiation intensity in illumination by means of an LED is also dependent on the angle.

Therefore it is another object of the invention to provide a better and more homogeneous illumination to enable improved evaluation.

The device according to the invention for recognizing particles in milk comprises a measuring surface and a housing. An illuminating device having at least one first light-emitting area and at least one second light-emitting area allows to illuminate the measuring surface. A central light beam of the first light-emitting area is directed at the side of the measuring surface opposite the first light-emitting area and a central light beam of the second light-emitting area is directed at the side of the measuring surface opposite the first light-emitting area.

This device according to the invention also has many advantages and it allows in particular to achieve an illumination that is more homogeneous than in the prior art.

The term “is directed at the side of the measuring surface opposite the first/second light-emitting area” in the sense of the present application is understood to mean that the central light beam is orientated nearer to the distal end than to the proximal end. The beams may be orientated over the end of the measuring surface.

With two illuminating means positioned on opposite sides, the central beams preferably cross in the center above the measuring surface.

According to another inventive proposal it is the object of the invention to increase the accuracy of the examination statements.

A temporary storage is provided to receive a milk sample from which specific quantities of milk can repeatedly be drained for measuring.

It is preferred for the temporary storage to drain the milk sample to be examined in multiple portions wherein each portion is being evaluated. This will considerably increase the statistical reliability of the statements in particular if the quantity of particles present in the milk is low. For evaluation it is possible to derive, apart from the absolute number of particles in each measurement, also the standard deviation and to determine and if required to output a statistical quality level. The temporary storage also enables to minimize foam. Such a temporary storage and specific embodiments thereof may be employed in all other embodiments of the invention.

If multiple measurements are taken, the values of the measurements may be counted cumulatively.

Preferably the temporary storage is connected with a valve through which air can be allowed to enter for conveying the milk portion to be examined to the measuring surface. Conveying may occur e.g. through atmospheric pressure or draining through gravity or by means of overpressure or negative pressure.

Milk may be drained through filtered air wherein pressure may be controlled by a throttle to optimally adjust the milk wave. The end of the milk wave may thus be drained at a lower rate. Preferably a valve means is used to feed the measuring housing in specific stages.

All of the embodiments preferably provide at least one control means for controlling. The control means may control the measuring process and e.g. the valves, the sensor, and the analysis program.

In each case the quantity of the individual particle types on the measuring surface may be determined. It is also conceivable to integrate the area to be allocated to any particle type and to use it absolutely or relative to the total area as a quality parameter. A parameter with the area integrated offers the considerable advantage that e.g. large clots are weighted more heavily than small clots. Two large clots are e.g. a clearer indication of an inferior milk quality than three minute clots.

Preferably all the embodiments provide at least one diffuser unit to obtain diffused light. For filtering out undesirable light components, one or multiple similar or different light filters may be provided.

Furthermore each device may comprise at least one detector means configured e.g. as a CCD sensor or a camera. The detector means may be gray-level- or in particular color-sensitive. Preferably the detector means comprises a photo lens, in particular a lens allowing magnification of the measuring surface. Zooming is also preferred.

Preferably a sight glass is disposed above the measuring surface. The distance between the detector means and the sight glass is preferably shorter than a mean distance between the sight glass and the measuring surface wherein the distance between the detector means and the sight glass is in particular shorter than a shortest distance between the sight glass and the measuring surface.

Herein depth of field is used such that any drops present on the inside of the sight glass will interfere as little as possible. Preferably the ratio is lower than 1, particularly preferably it is lower than 0.75 and even lower if possible, e.g. lower than 0.5.

Therefore it is the aim to dispose the sensor or the camera as close as possible to the sight glass such that any drops adhering to the sight glass may be compensated.

A specific embodiment of all of the embodiments provides a rinsing nozzle to rinse preferably the sight glass and/or the sample holder with a cleaning agent.

Preferably a nose is provided at an inlet area to prevent that the sight glass is splashed. The nose also offers the advantage of spreading and steadying the stream.

According to another inventive idea it is an object of the invention to provide a device which substantially prevents drops on a viewing glass.

Above the measuring surface there is disposed a partition wall which is inclined to the horizontal and optically transmissible, and through which the measuring surface can be viewed.

The inclination of the partition wall offers numerous advantages. The partition herein is a viewing glass and is configured transparent. Preferably the partition wall is configured as a sight glass.

This embodiment also allows manual inspection. A sensor does not need to be present then. In this way such a device can be manufactured and offered at particularly low cost. Otherwise the device can operate automatically. The milker only checks with a quick glance whether particles are present and what kind if any.

However, it is also possible and preferred to provide this embodiment with one or multiple sensors to apply a measuring method as described above.

Preferably the sight glass is positioned at an angle to the horizontal of larger than 20°, preferably larger than 30° and particularly preferably between approx. 40° and approx. 60°. An appropriate angle may be between 40° and 55°. One embodiment provides an angle of approx. 48° to the horizontal.

An inclination to the horizontal facilitates running off of any adhering drops. The sight glass may in particular at low temperatures get covered in condensation which impairs the free view of the measuring surface. An inclination considerably reduces the problem caused by drops.

Specific embodiments of the devices according to the invention provide a heatable sight glass. For example heating wires or heating areas may be used which may e.g. be transparent. The heating means may operate electrically or thermally. Supplying warm or hot air or heated water is also conceivable.

Preferably the sight glass is coated or nano-coated to improve the running off and/or spreading of any present drops.

Also, a variant of one or a combination of multiple embodiments as described may be employed. According to the invention, a milk sample to be examined is conveyed to a measuring surface and an image of the measuring surface is captured. At least one object recognition rule is used to distinguish at least two types of detected or detectable particles.

The invention generally offers the option of separating clots and/or foreign particles in milk. Subsequently clots can be recognized and distinguished from other particles. The device offers the option of detecting and making visible, particles such as straw, sand, and clots. Other particle types can also be recognized.

In preferred specific embodiments “harmless” particles such as straw or sand can readily be distinguished from clots and separately recognized. Known methods that only identify or count particles would recognize also “harmless” particles as clots. In such a case the milk would wrongly not be used further in whole or in part. One possible further use is feed for calves or possibly placing on the market. This depends on the type of particles present and on a parameter that is characteristic of the frequency of particles or their mass, surface or composition and/or the cause. Without the invention the total output of a dairy farm might possibly be lower.

The invention allows to obtain information in every milking operation which allows drawing a number of conclusions. This can be most helpful in particular in reducing and preventing of udder disorders in the barn. The present invention allows to draw conclusions on the quality of udder cleaning or the quality of the cleanliness in the barn and stalls. For example a defective cleaning brush or incorrect bedding or a defective cleaning unit for the barn can thus be detected. The milk output and the milk quality can thus be increased even further.

The invention may be employed as a bypass in the existing milking system, preferably as a bypass for the long milk hose. A portion of the milk from an animal is rerouted into a buffer container for measuring.

This may occur on the level of the udder or of the teats. For example for cows one device according to the invention may be provided per quarter and for goats for example two devices according to the invention may be employed for each animal.

It is also conceivable in a milking parlor to equip with the invention only specific milking places or e.g. the good milk line. This allows the farmer or the operator to lead animals due to be observed to the milking places so equipped to enable better health checks on the animals.

It is also conceivable to equip with the invention e.g. one in two, three or four or X milking places in a milking parlor or in a milking carousel. Given for example one in four milking places so equipped and two milkings a day, the operator will on average obtain a measuring result every two days. He can then react comparatively early. Given three milkings and one in three milking places equipped will provide the farmer with a measuring result every day on average which as a rule will be frequently enough.

Other embodiments allow that in a milking parlor (e.g. carousel) e.g. every place is equipped with a sampling device and samples are conveyed to one or more devices according to the invention to perform multiplexing.

It is also possible that in a milking parlor, milk is constantly tapped off the central milk line (in particular the milk line for “good” milk) and fed in portions to a device or alternating to multiple devices. If e.g. clots are recognized, the clots must originate from one of the animals at present in the milking parlor (or in the milking carousel). Given a milking parlor with 16 milking places, these 16 animals should e.g. be examined by a veterinary but not the whole herd of e.g. 100 or 1000 animals. Separate detection in groups will limit the time and expense for examination to the group concerned.

It is also conceivable that as particles are detected in the examined milk, a (perhaps additional) milk sample is diverted for analysis. This may be performed subsequently by means of a separate device through the farmer or at an external place.

The milking process can be controlled in relation to the result of recognition so as to convey the milk yield either to the vessel for good or the vessel for bad milk. Also, an indication or a warning signal may be emitted to initiate e.g. manual separation.

In recognition the covered area may be determined for each particle type or for the most relevant particle types to assign the milk to a specific quality grade. It is also conceivable to determine a degree of brightness or coloring or a degree of average size or a degree of area covered for each particle type. Also the quantity of particles or objects per type may be determined.

Furthermore additional sensors may be provided such as a conductivity sensor, a temperature sensor or a cell count sensor which counts each somatic cell individually.

An embodiment of the invention will now be described with reference to the Figures.

### BRIEF DESCRIPTION OF THE DRAWINGS

FIG. 1a schematic general view of the device according to the invention at a milking place; and

FIG. 2a sectional side view of the device according to the invention,

FIG. 3a schematic illustration of the process flow,

FIG. 4a schematic image with straw objects, and

FIG. 5 an image with a schematically illustrated clot.

### DETAILED DESCRIPTION OF THE PREFERRED EMBODIMENTS

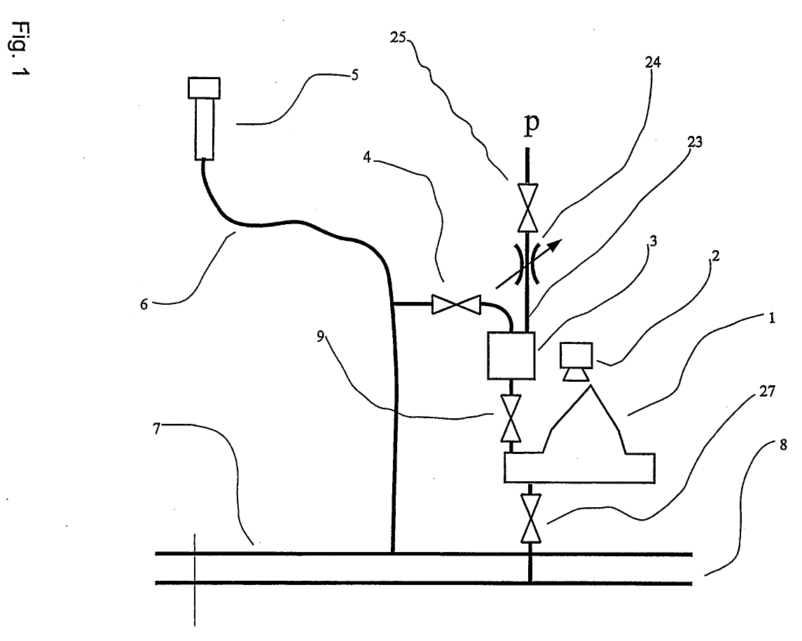

FIG. 1 schematically illustrates the structure of an embodiment of a device 1 according to the invention.

This embodiment shows a milking method operating individually for each quarter. It is also conceivable to install the device subsequent to a milk collection piece (not shown) for analyzing the total milk yield. Furthermore another embodiment of the device is conceivable which with a milking method operating individually for each quarter only requires one measuring device 1 in that a suitable valve arrangement is provided to consecutively feed milk to the measuring device 1.

During milking, milk flows out of the udder teats, being routed through the teat cup 5 and the long milk hose 6 into the “good” milk line 7.

At the start of or later during milking, part of the milk is diverted through a valve 4 into the storage tank 3 which also serves as a temporary storage for a milk sample. After filling the storage tank 3 or filling up with a specified sample quantity, the valve 4 will shut off the inlet to the storage tank 3.

The storage tank 3 serves on the one hand as a temporary storage for the milk and on the other hand to eliminate/minimize foam. This is realized in that the foam will float on top due to its density being lower than that of milk and in that the milk to be examined is drawn from the bottom.

For analysis, a first portion of the milk in the storage tank 3 is drained into the measuring device 1 through additional valves 9 and 25 while the valve 27 remains shut. The valves 9 and 25 are briefly opened and immediately shut again to convey a sample into the measuring device 1.

The “bad” milk line 8 may be under atmospheric pressure. In this case it is preferred that the valves 9 and 27 are non-controlled check valves since the valve 27 will then lead toward atmospheric pressure. Thereafter there may be provided instead of a milk line for “bad” milk, a sample container the contents of which may be examined separately e.g. in an external laboratory.

At the start of the milking operation there is a vacuum in the milk line 7 and the line 6 and in the line toward the valve 4. The storage tank 3 and the measuring chamber are under atmospheric pressure and the valve 25 is closed. In this embodiment the storage tank 3 is filled and then put under atmospheric pressure e.g. by opening the valve 25 while the other valves remain shut. Air will flow through the valve 25 via the throttle 24 into the storage tank 3.

Subsequently the valve 25 can be opened, being controlled such as to drain a sample to be examined into the measuring device 1 since the valve 9 opens automatically. It is also conceivable to feed compressed air through the valve 25 during draining. The pressure of the compressed air will then preferably be controlled via the throttle 24 such that draining of the milk from the storage tank will be regulated and quiet. This is an advantage since a quiet, slow flow will prevent that particles are carried off the measuring surface which may happen with too high flow rates.

Draining may also occur in the form of a milk wave where a milk portion is drained out of the temporary storage. To this end, valves 9 and 25 are opened and after an adjustable interval closed again. The milk will then be conveyed through a small shock wave with a subsequent “milk cauda” into the measuring device 1.

The shock wave or shock front flushes off any particles remaining from the previous measurement if no cleaning was done. The milk cauda allows any particles present in the milk portion to be deposited since the flow rate is low and diminishes still further.

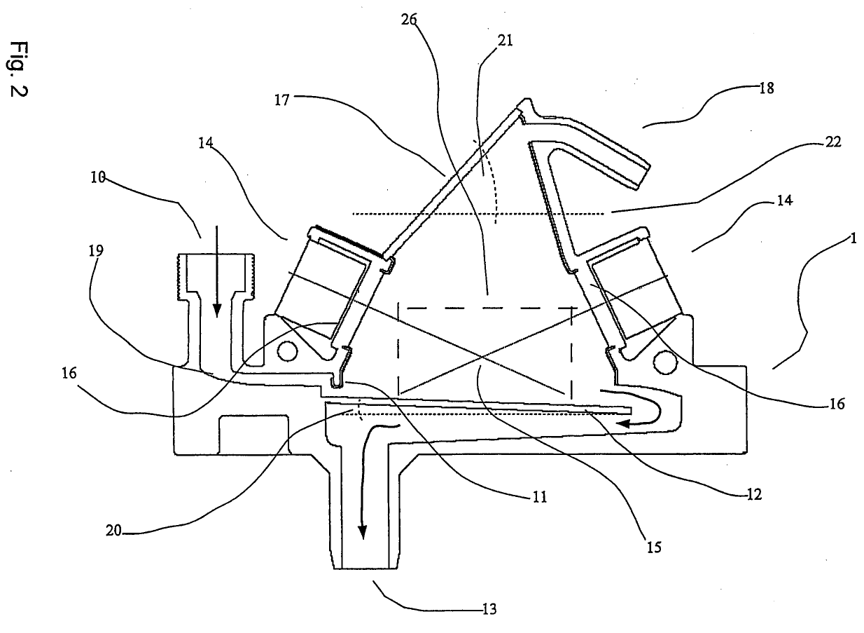

As shown in FIG. 2, the milk flows into the inlet nozzle 10 of the measuring device 1, through the pipe elbow 19 against the nose 11. The pipe elbow 19 and the nose 11 serve for a guided inlet of the milk stream and for spreading of the milk sample across the whole width of the sample holder 12. The nose 11 prevents that any drops splash up to the sight glass 17. The milk stream will now advantageously be conveyed first onto the sample holder 12 through a shock wave which flushes off any possibly adhering particles/clots from a previous measurement. Rinsing may instead occur before measuring and sample liquid may flow in with a slow wave.

Due to the angle 20 the milk flows over the sample holder 12, continues to return beneath the sample holder 12 and then drains through the outlet 13. The outlet may be attached directly at the end of the sample holder 12 (not illustrated herein).

Any or at least some of the particles possibly present in the milk sample or the milk portion, such as clots, remain on the measuring surface 26 or in the viewing area. The reason for the particles/clots remaining is that in the embodiment:
The angle 20 of the inclined sample holder 12 is between approx. 1° and approx. 5°, advantageously at approx. 2°; two areas at different inclinations are also possible where the first incline is steeper than the second;
The surface is textured and has a roughness of approx. 27 to 30 according to VDI 3400 (edition 06/1975); this roughness corresponds to a roughness height of 2.2 to 3.2 μm for demolding inclines of 1.5% to 1.8%; other values are possible such as roughness heights of 0.4 to 18 μm, in particular between approx. 1.6 μm and approx. 4.5 μm which corresponds to roughness values of 24 to 33;
The liquid spreads out wide across the sample holder through the pipe elbow 19;
The material allows an even spread of liquids. Preferably plastic should be used e.g. ABS (acrylonitrile-butadiene-styrene polymer). In this way the forming of streamlets is inhibited which would lead to such a flow rate of the milk as to flush off virtually all of the particles. Use of a hydrophilic material is preferred over hydrophobic material.
The liquid stream flows very slowly toward the end, “milk cauda”; this is achievable for example by abruptly stopping the feed.

It is readily possible to achieve the success according to the invention with other values of roughness and/or of the angle 20. A principle is that roughness, material properties and angle 20 interact with one another. The larger the roughness, the larger the angle 20 should be. As roughness increases, cleaning the device may however be impeded.

Now at least two light sources or light ranges of a light source permanently or briefly illuminate the sample holder 12 while at least one image is captured by means of a sensor 2. The illumination 14 is configured herein such that:
The light sources lie opposite one another to eliminate/reduce shadows.
The centers of each light beam 15 are incident on the opposite side of the viewing area or the measuring surface 26; this will generate a largely even illumination intensity over the entire measuring surface 26.
The dispersion angles are such that substantially no reflections enter the camera. A very flat angle of e.g. approx. 25° is advantageous. However, other angles are also possible.
Alternate illumination of particles creates shadows which supply a statement about the third dimension.
White light or yellow light is preferably used which enhances the contrast of pale objects.

Furthermore a diffusing glass 16 for each light source is advantageous. Said diffusing glass 16 refracts the light beams, making the light spread more homogeneously. Intense reflections are thus reduced. Illumination by means of e.g. luminescent foil or other illumination means emitting planar light may allow to omit a diffusing glass 16. A ring-type illumination may be employed that is disposed on specified sides or around the measuring surface and emits light to the measuring surface.

The camera 2 is hydraulically separated from the measuring device 1 by a heated sight glass 17. The measuring device is under intermittent negative pressure. Heating prevents the sight glass 17 from fogging. This is essential in a warm/moist ambience such as freshly milked raw milk since with cool ambient temperatures or cool rinsing water, measuring may become difficult or even impossible. The heating device is advantageously applied on the sight glass (K glass) as an electrically conductive, current-carrying coat. Heating by heating wires is also possible but it might impede the viewing range of the camera. Such interference can, however, be computed out of an image.

Another advantageous feature of a separate inventive idea is to position the sight glass 17 at an angle relative to the horizontal 22 since any adhering drops can more easily run off. Preferably the angle is larger than approximately 20°, better, larger than approximately 30°, e.g. between 40° and 55°, particularly preferably at an angle 21 of approximately 48°.

A larger angle would support the running off but the intensity captured by the sensor 2 would be reduced due to reflection loss. In dependence on the refraction index of the glass and an applied coat if any, and on the illumination intensity and sensor sensitivity a suitable range will result. The use of suitable polarized light may reduce the influence.

To support the running off of the drops, the glass may be nano-coated which would e.g. further enhance the running-off effect. Said coating may be hygroscopic so as to cause the liquid to thinly spread on the glass.

In order to largely reduce adverse effects of adhering drops which may still occur despite all countermeasures, the effect of depth of field is preferably utilized. For this purpose the sight glass 17 ought to be as far distant as possible from the sample holder 12 in relation to the focal length and size of the sample holder 12. For the same reason the camera 2 should be placed as closely as possible to the sight glass 17.

Now, when the particles/clots have been separated from the milk, the sensor 2 captures an image of the measuring surface 26. The sensor 2 which may e.g. be configured as a camera, is arranged substantially at a right angle to the sample holder. The image is evaluated by an analysis means. The analysis means performs a detection of particles on the measuring surface. Thereafter, recognized particles are classified to allow a statement on the type of any particles detected and thus on the quality of the milk. In dependence on the result the further milking process can moreover be controlled.

In the embodiment a dark sample holder 12 is used. This is advantageous since it will generate the largest possible contrast to the clots which will advantageously effect the later analysis. The basic device is also suitable for detecting “non-clot particles” such as straw or wood chips and for determining the types. In case priority is given to recognizing such particles, another color of the sample holder to increase the contrast is conceivable depending on the desired recognition precedence.

It is furthermore possible to detect blood present as swirls. It is also possible to detect tissue. Depending on the result, the fastest possible examination and treatment of the animal concerned can be initiated.

Analysis is carried out by means of standardized image processing. Analysis will include at least one of the following object recognition rules. The object recognition rules should be understood as principles, deviations being conceivable in individual cases. A rule that is fulfilled is indicative of the type of particle. As the number of fulfilled rules increases so will the reliability of the result increase. In individual cases, a fulfilled rule may be disproved by one or more others.

Multiple object recognition rules may be considered in this sequence or in any other appropriate sequence:
R1 Clots are pale.
R2 There is little color variation within one clot.
R3 Clots have no or only very few parallel contours or discoloring.
R4 Clots are characterized in that they are rough, non-symmetrical in outer contour which cannot be readily classified into simple geometric basic shapes.
R5 Outer contours are clearly distinct from the background. Any variations in hue, saturation and/or intensity occur over short distances or a small number of pixels.
R6 A “milk pool” which can be detected at the edge of almost all objects, shows variations in hue, saturation and/or intensity over many more pixels. A “milk pool” is a thin milk film remaining on the measuring surface; a thin milk film often remains around particles.
R7 Clots are solid and rarely formed hollow.
R8 The color of clots usually ranges from white to pale yellow or light ocher.
R9 Discolorations recognized e.g. yellow, ocher or brown may be slightly marbled, shaded or swirled.
R10 The outer contour of a clot may range from roundish to worm-shaped.
R11 Sickle-shaped clots can be observed repeatedly.
R12 The size of a clot in its largest dimension ranges from approx. 0.1 mm up to several millimeters.
R13 Foam/bubbles tend to take on the background color in their centers, having a round or roundish outer contour. Its color ranges from whitish (milk colored) to background-colored.
R14 Straw tends to show an approximately parallel grain.
R15 Moreover, straw is distinguished by sharp, jagged edges with very few or no radii.
R16 Straw is golden, brown, and/or gray brown.
R17 Feces are brown or green or speckled in these colors.
R18 Feces are rather roundish.
R19 Wood chips are brown, gray in color.
R20 The edges of wood chips are straight, having next to no radii.
R21 Wood chips frequently show at least one pointed tip.
R22 Unlike straw, wood chips usually do not show any distinct grain.
R23 Sand has a core that takes on the background color (transparent) or is light brown and roundish.
R24 Very bright spots at or in other objects are reflections.
R25 Reflections will be found in the direction of the light source(s). The close ambience must be examined for evaluation.

Detection is performed on the basis of the rules described and any recognized particles are typified. Each rule may be weighted. For weighting the individual object recognition rules, a conventional control or analysis unit may be employed which may include a fuzzy logic system.

The process is preferably repeated until the storage tank 3 is substantially completely drained. This enhances the statistical reliability. It is also conceivable to make decisions based on one pass.

The inflow rate according to the invention is configured such that the milk portion in the next run flushes off in the “milk wave” described above any particles/clots that may have remained from the previous sampling. After milking the device may be cleaned every time with a rinsing fluid. According to the invention this occurs on the one hand through the rinsing line 18 and on the other hand through the inlet nozzle 10.

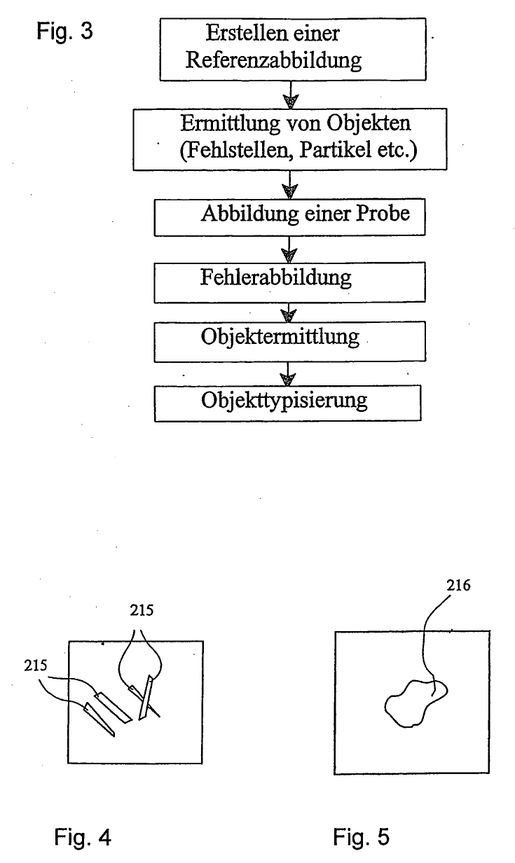

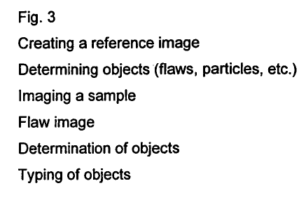

The process control for determining the quality of milk will be described below with reference to FIG. 3. The process of quality determination starts with creating a reference image. This reference image is examined for defects, scratches, particles or the like. This is intended to ensure that defect objects are excluded from subsequent analysis. A reference image is preferably created before each milking operation or else before (and/or after) each reading. Criteria may be established in respect of the reference image. For example the reference image can establish whether particles from a previous milking operation are deposited on the measuring surface. It can also be established whether e.g. cleaning of the measuring surface has been successful.

Instead of extracting a flaw image, ambience comparison may be performed. The sample image will be examined for the presence of large continuities in portions within a specific hue, saturation, and intensity range.

Another step is provided for the determination of objects. To reduce the time and work and the amount of data required for the determination of objects, one portion of interest is preferably identified which portion of interest is characteristic for the determination of the at least one parameter. For example a search is performed for areas with different hues, saturation, and/or intensities which differ from other portions or lie outside a predetermined tolerance zone.

Differences in hue, saturation, and/or intensity outside a specific tolerance zone are indicative of a contour or a transition from one object to the next. If flaws are imaged in digitized form, object transitions or edges may preferably be detected by gradient formation or a boundary locating routine. This will allow recognition of individual objects.

Using optical systems involves the risk that when creating a sample image, reflections appear which have been detected in flaw imaging as flaws or objects. The aim is therefore to exclude such objects. The same problem occurs if for example a bubble had been present on the sample holder or the measuring surface, at the time of creating a sample image. To exclude bubbles and reflections, intensity, hue, and/or saturation variations are preferably determined close to an object surface. If such part objects are detected, the question will be raised whether very bright spots are present in the direction of the light source and directly adjacent thereto, very dark spots. If this is the case, a reflection or a bubble may be present. This object can be excluded from further analysis.

The remaining object edges are determined in view of their parameters. Depending on the parameters, the objects are assigned to a predefined typing class or classification class. Depending on the object type, a decision can be made whether the objects are “harmless” objects such as wood chips or straw particles or whether the object is a clot indicative of a pathological change of the udder.

The analysis of the milk sample and determination of the quality will also take into account whether and to what extent and what types of “harmless” objects are present. There will preferably be an output to enable the operator to improve the values in the future e.g. by way of indicating the necessity of improving on udder checks or cleaning.

Object types may be determined on the basis of various criteria. These criteria also depend on the color model employed. If the color model is the HSL (hue, saturation, lightness) color model, any other color model may be used as well although the terms of hue, saturation and intensity must then be replaced or adapted to the model used otherwise. With incident lighting, a dark background is preferably used. The criteria should again be adapted accordingly. When using transmissive read, the criteria should be adapted accordingly since e.g. sand grains could no longer be detected.

FIG. 4 is a schematic illustration of straw particles—objects 215. Clots are usually bright. Straw particles are generally not very bright such that it can be assumed that the object 215 is not a clot.

As a rule there is little color variation within one clot. Color variations in straw particles are great so it can be concluded that it is very probably not a clot.

The object 215 comprises parallel contours and discoloring. As a rule, clots have no or very few parallel contours or discoloring so it can be concluded that the object 215 is not a clot.

Clots are typically rough, non-symmetrical in outer contour which cannot be readily classified into simple geometric basic shapes. The outer contour of the object 215 is highly symmetric such that it can be concluded that this is very probably not a clot.

The illustration in FIG. 4 shows multiple objects. At the edges of many areas, the hue, saturation and/or intensity vary within a few pixels. This allows the conclusion that some outer edges are present such that multiple objects 215 exist. The observer will also realize that the objects 215 are comparatively solid. Clots also tend to be solid. Only rarely are they hollow such that it could be assumed that the object 215 is a clot. A determination of the color will show that the object 215 is yellow, brown and gray but not bright. The color of clots usually ranges from white through pale yellow to light ocher. One can thus draw the conclusion that this is very probably not a clot.

Discolorations in clots e.g. yellow, ocher or brown may be slightly marbled, shaded or swirled. Object 215 does not show any marbling or swirls so it can be assumed that it is not a clot.

Clots tend to have a circular outer contour. They may have a worm-like shape. Object 215 is neither roundish nor worm-shaped such that it is very probably not a clot. Sickle-shaped clots are also possible. The object 215 does not have such a shape.

The size of a clot in its largest dimension ranges from approx. 0.1 mm up to several millimeters. Some of the objects 215 have such a size such that they may be clots.

Foam and bubbles tend to take on the background color in the center, typically having a round or roundish outer contour. The color of the outer contour ranges from whitish to background-colored. Viewing the objects 215 in their entirety will reveal a background-colored core. It may be foam.

Straw tends to show an approximately parallel grain. Straw is furthermore identifiable in that it has sharp, jagged edges with very few small or no radii. The objects 215 can be found to exhibit parallel lines. Furthermore, sharp edges with few radii can be recognized such that this is for example very probably straw.

Additional criteria may be established for other objects. Thus it may occur that in addition to straw, feces, wood chips or sand enter the milk. Different criteria may be established for such particles. For example feces will as a rule be brown or green or speckled in these colors. Feces occur rather roundish.

Wood chips tend to be brown or gray in color. Their edges tend to be straight, having next to no radii. Wood chips frequently show at least one pointed tip. Unlike straw, wood chips usually do not show any distinct grain. Sand has a core that tends to take on the background color (transparent) or is light brown and roundish.

Existing definitions of other objects will also be checked when determining objects. The object 215 for example has the colors brown, yellow, and gray. However, there is no green such that the object 215 is very probably no feces. No particular roundness can be detected.

The object 215 is gray/brown among other things. It is possibly a chip. Sharp edges with few radii can be detected. This would indicate the possibility that the object 215 is a wood chip. A clearly defined point is not detectable such that it is very probably not a wood chip.

The distinctive grain suggests that it may be straw. The core of the objects 215 is neither background-colored nor light brown such that sand can very probably be excluded. Nor can very bright spots be detected on the flaw image and thus reflection is absent.

Based on determination of the particular assignations which can also be referred to as object recognition rules there is the high probability that the objects 215 are straw. Absent such identification the objects 215 would possibly be recognized as clots. This might result in that the good milk would have been graded as non-marketable and the animal might possibly have been treated for mastitis. Thus, however, the milk output of a dairy farm would have been reduced without a good reason.

For example if in flaw imaging an area has been identified containing an object 216 as in FIG. 5, the object 216 will by typified as is done in object determination for the objects 215. The object 216 is bright such that it may be a clot. There is little color variation within the object 216. It might be a clot.

The object 216 does not comprise any parallel contours. One can thus draw the conclusion that it is most probably a clot. One can recognize that the outer contour is rough which is indicative of a clot. If shades can be determined within the object 216 and hue, saturation and/or intensity vary over only a few pixels it can be assumed that the object 216 is only one object. If a variation over multiple pixels of hue, saturation and/or intensity cannot be detected one can draw the conclusion that this is probably not a “milk pool”.

If the object is found to be solid it may be a clot. If the object 216 is white in color and in the upper area, light ocher, it is very probably a clot. If in the upper area a shade-like bright ocher area can be detected it may probably be a clot. A roundish shape of the outer contour is indicative of a clot. The size of the object 216 would again indicate that it might be a clot.

The center area of the object 216 does not show a background-colored region. Nor can a round outer contour be recognized such that the object 216 is probably not a bubble. Nor can any parallel grain be recognized such that the object 16 is very probably not a bubble.

Although the object 216 comprises jagged edges, there is some roundness at the edge. The object 216 may possibly be straw but it is unlikely. The color is not golden brown and/or gray brown such that the object 216 is probably not straw. Nor is the object colored brown or green nor is it speckled in these colors such it can be concluded that the object 216 is probably not feces. However, the roundish shape of the object may be indicative of possibly present feces.

Furthermore the other object types such as wood chip, sand etc. might have to be queried. Dependent on the entire queries the conclusion can be drawn that the object 216 is a clot.

In all of the embodiments according to the invention a distinction can in particular be made between the object types particle object and non-particle object. Also, a distinction can be made between the object types mineral particle objects and biological particle objects. The object type non-particle object preferably comprises the object types bubble object and/or reflection object and/or flaw object.

With the method at least one portion of interest is identified which is characteristic of at least one object. Moreover at least one boundary locating routine is performed to determine objects. Preferably at least one parameter is specified which is in particular captured optically. Preferably an image of the measuring surface is captured. The parameter can be derived from the brightness and/or from the outer contour of an object. The contrast and/or the color may also be employed. The parameter can be determined through incident lighting and/or transmissive read. Preferably at least one characteristic value of at least one object is determined. Also, gradient formation may be performed in view of at least one physical quantity, in particular in view of the optical, acoustic and/or electrical properties, or the hue, intensity, saturation, electrical conductivity, electrical capacity, reflection and/or transmission.

The frequency of individual object types is in particular determined. The frequency of individual object types and/or the object sizes of the different object types and/or the relative or absolute area covered allows to derive a quality grade. Preferably the milk quality is first determined and thereafter the milk is either conveyed to the marketable milk container or it is discarded.

1. A device for recognizing particles in milk comprising: a measuring surface and a housing, wherein the measuring surface receives milk and has a specific surface roughness.

2. The device according to claim 1, wherein the surface roughness of the measuring surface has a typical height in the range of 0.3 μm to 20 μm.

3. The device according to claim 1, wherein the surface roughness of the measuring surface has a value of 27 to 30 according to VDI 3400, edition 1975-06.

4. The device according to claim 1, wherein the measuring surface is inclined relative to the horizontal at an angle between about 0° and about 10°.

5. The device according to claim 1, wherein the measuring surface comprises at least one layer of a hydrophilic material.

6. The device for recognizing particles in milk in particular according to claim 1, and further comprising an illuminating device having at least one first light-emitting area and at least one second light-emitting area, wherein a central light beam of the first light-emitting area is directed at the side of the measuring surface opposite the first light-emitting area and wherein a central light beam of the second light-emitting area is directed at the side of the measuring surface opposite the first light-emitting area.

7. The device for recognizing particles in milk in particular according to claim 1 and further comprising a temporary storage to receive a milk sample from which specific quantities of milk can repeatedly be drained for measuring.

8. The device according to claim 7, and further comprising at least two opposite illumination units which light the sample holder at such an angle that the focus of the light beams is incident on the opposite side of the measuring surface.

9. The device according to claim 1, and further comprising at least one diffuser unit is provided to obtain diffused light.

10. The device according to claim 1, and further comprising at least one detector means.

11. The device according to claim 1, and further comprising a sight glass disposed above the measuring surface.

12. The device according to claim 1, and further comprising a sight glass positioned at an angle to the horizontal of larger than 20°.

13. The device according to claim 1, and further comprising a sight glass that is heatable.

14. The device according to claim 11, wherein the distance between the detector means and the sight glass is shorter than a mean distance between the sight glass and the measuring surface wherein the distance between the detector means and the sight glass is preferably shorter than a shortest distance between the sight glass and the measuring surface.

15. The device according to claim 11, wherein the sight glass is coated to improve the running off of milk drops.

16. The device according to claim 11, and further comprising a rinsing nozzle to rinse preferably the sight glass with a cleaning agent.

17. The device according to claim 11, and further comprising a nose at an inlet area to reduce splashing of the sight glass.

18. The device according to claim 1, and further comprising a temporary storage to temporarily store a milk sample to be examined.

19. The device according to claim 1, wherein a milk sample to be examined can be drained in multiple portions and wherein each portion may be evaluated to obtain better statistical reliability of the analysis result.

20. The device according to claim 18, wherein the temporary storage is connected with a valve through which air can be allowed to enter for conveying the milk portion to be examined to the measuring surface.

21. The device according to claim 20, wherein the valve feeds the measuring housing in specific stages.

22. The device according to claim 1, and further comprising at least one controller.

23. The device for recognizing particles in milk in particular according to claim 1, and further comprising a partition wall which is inclined to the horizontal and optically transmissible, and through which the measuring surface can be viewed.

24. A method for recognizing particles in milk, comprising the steps of: conveying to a measuring surface; capturing an image of the measuring surface and employing at least one object recognition rule to distinguish at least two types of detected particles.

25. The method according to claim 24 wherein a particle count serves to analyze milk qualities.

26. The method according to claim 24, and further comprising the step of: determining least one area proportion value of at least one particle type.
